(19) United States
(12) Patent Application Publication
(10) Pub. No.: US 2003/0051107 A1
(43) Pub. Date: Mar. 13, 2003

(54) System for controlling attributes of storage device

(76) Inventors: Hiroshi Shimizu, Chiba-shi (JP); Hiroshi Miyazaki, Chiba-shi (JP)

Correspondence Address: ADAMS & WILKS, 31st Floor, 50 Broadway, New York, NY, 10004, US

(21) Appl. No.: 10/199,845

(22) Filed: Jul. 19, 2002

(30) Foreign Application Priority Data
Sep. 13, 2001 (JP) 2001-278386

(51) Int. Cl. G06F 12/00

(52) U.S. Cl. 711/154; 711/163

(57) ABSTRACT

When a mode switch instruction is given via a network or from a switch unit, an attribute controller sends an attribute-set-request signal to a storage device managing unit. An attribute control unit reads out from an attribute-setting-status storage unit attribute information corresponding to the attribute-set-request signal, and stores this into an attribute information managing unit to thereby update the storage device attribute information that is being recognized by the OS, and issues modification permission to the attribute controller. The attribute controller receives the modification permission and instructs a disk control unit to change the attributes of the storage device to attribute information that corresponds to the mode switch instruction. In response to the instruction, the disk control unit reads out the attribute information from the attribute setting storage unit and changes the attributes of the storage device, to thereby synchronize the attributes of the storage device with the attributes being recognized by the OS. Accordingly, this prevents an operational abnormality from occurring when changing the attributes of the storage device.

### BACKGROUND OF THE INVENTION

1. Field of the Invention

The present invention relates to a system for controlling attributes of a storage device used with a computer.

2. Description of the Related Art

Conventionally, computers have been used for a variety of uses including use as a server system connected with a network. In such a computer, there is used an external storage device composed of a magnetic disk or the like.

For example, in a server system connected to a plurality of terminals via the network, the external storage device is divided into a plurality of storage areas by setting partitions, and software and data are stored into each of the storage areas.

The server system is available for use via the network, and the stored content in the storage device can be referenced via the network, and it can be upgraded, added to, updated, and otherwise modified at any time as needed.

Further, in order to ensure security when used through the network and in order to enable a system administrator to modify the stored content in the storage device, each of the storage areas is set with a read/write state, a read only state, or another such attribute indicating a state in which the storage area functions as the storage device. Further, each storage area is constituted as capable of switching its attribute according to a mode in which the server system is used.

For example, in a case where a storage device is used in a Web server system, the storage device is divided into a plurality of storage areas (partitions), and in each storage area there are stored, for example, an operating system (OS), a first content data and a second content data, and there is provided a swap area and the like.

In an open mode in which the modification of the stored content in the storage device is prohibited, the attribute of the swap area is set to the read/write state, and all other storage areas are set to the read only state. In a maintenance mode in which a content data administrator is allowed to modify his/her own content data, the attributes of the OS area, the first content data area and the swap area are set to the read/write state, while the second content data area is set to the read only state. Further, in a full-maintenance mode in which a server administrator is allowed to modify all the content in the storage device, all of the storage areas are set to the read/write state.

Accordingly, it becomes possible to ensure security and modify the content of the storage device according to how the server system is used.

However, in a case where the server system uses an operating system such as Linux or Unix, information about the attributes of the storage device is stored on the OS side, and the OS controls the storage device based on the stored attribute information. Therefore, if the attributes of the storage device are suddenly switched, the storage device attributes which are recognized by the OS and the attributes set for the storage device is set with will not match each other. Thus, there is a problem that the operation of the server system will become abnormal.

### SUMMARY OF THE INVENTION

An object of the present invention is to prevent an operation abnormality from occurring when switching the attributes of a storage device.

In accordance with the present invention, there is provide a system for controlling attributes of a storage device, characterized by comprising: a storage device; storage device managing means including attribute information storage means for storing attribute information indicating the attributes of the storage device, which controls the storage device based on the attribute information stored in the attribute information storage means and also modifies the attribute information stored in the attribute information storage means to attributes corresponding to an attribute-switch-request signal; attribute-switching-signal generating means for receiving an attribute-switch-request signal and outputting to the storage device managing means the attribute-set-request signal which corresponds to the attribute-switch-request signal, and also for outputting an attribute-switching-signal that corresponds to the attribute-switch-request signal; and attribute switching means for switching the attributes of the storage device to the attributes corresponding with the attribute-switching-signal.

The storage device managing means is provided with the attribute information storage means for storing the attribute information of the storage device, and it controls the storage device based on the attribute information stored in the attribute information storage means and modifies the attribute information stored in the attribute information storage means to attributes which correspond with the attribute-switch-request signal. The attribute-switching-signal generating means receives the attribute-switch-request signal and outputs to the storage device managing means the attribute-set-request signal corresponding to the attribute-switch-request signal, and also outputs the attribute-switching-signal that corresponds to the attribute-switch-request signal. The attribute switching means switches the attributes of the storage device to the attributes that correspond to the attribute-switching-signal.

Here, the function in which the storage device managing means controls the storage device is achieved by a CPU executing the operating system. Further, the operating system may be an operating system in which it is necessary to synchronize the storage device attributes which are being recognized by the operating system with the attributes that are set in the storage device.

Further, the operating system may also be Linux or Unix.

Further, a configuration is also possible in which the storage device managing means receives the attribute-set-request signal and outputs an attribute modification permission signal, and then, in response to the attribute modification permission signal, the attribute-switching-signal generating means outputs the attribute-switching-signal.

Further, a configuration is also possible in which in response to the attribute-set-request signal, the storage device managing means modifies the attribute information stored in the attribute information storage means to attributes that correspond to the attribute-set-request signal and then outputs the attribute modification permission signal.

Further, a configuration is also possible in which the attribute-switching-signal generating means has a time-measuring means which starts a time-measuring operation simultaneous with the outputting of the attribute-set-request signal, and when the time-measuring means measures out a given time duration before receiving the attribute modification permission signal, the output of the attribute-switching-signal is forced.

Further, a configuration is also possible in which the storage device is divided into a plurality of storage areas with at least the operating system and data stored therein.

Further, a configuration is also possible in which the attribute-switching-signal generating means receives the attribute-switch-request signal via a network.

Further a configuration is also possible in which there is further provided a switch unit for inputting the attribute-switch-request signal, and the attribute-switching-signal generating means receives the attribute-switch-request signal from the switch unit.

Further, a configuration is also possible in which the attribute-switching-signal generating means comprises attribute-setting-status storage means for storing the attribute information set in the storage device; and attribute control means for responding to the attribute-switch-request signal by outputting the attribute-set-request signal, and responding to the attribute modification permission signal by outputting as the attribute-switching-signal the attribute information stored in the attribute-setting-status storage means.

Further, a configuration is also possible in which the attribute-setting-status storage means stores the attribute information inputted from the network or from the switch unit.

### BRIEF DESCRIPTION OF THE DRAWINGS

In the accompanying drawings:

FIG. 1 is a block diagram of a Web server according to an embodiment of the present invention; and

FIG. 2 is a diagram showing attributes of a storage device 106 used in the embodiment of the present invention.

### DETAILED DESCRIPTION OF THE PREFERRED EMBODIMENTS

Hereinafter, explanation is made of a system for controlling attributes of a storage device according to an embodiment of the present invention with reference to the drawings.

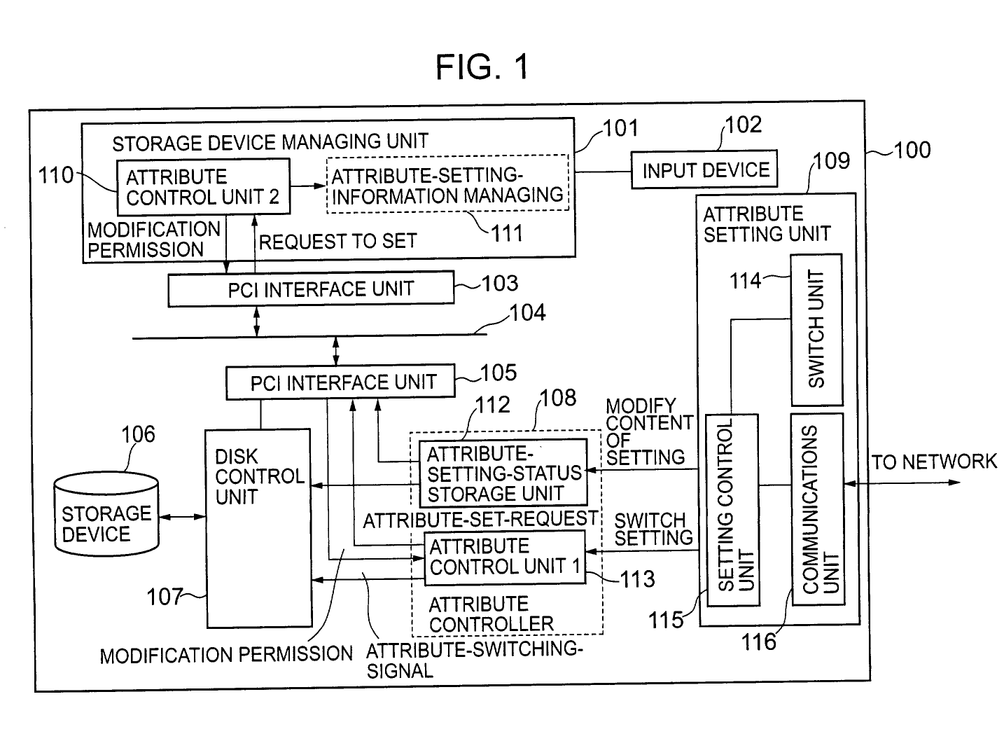

FIG. 1 is a block diagram showing a server system used in the embodiment of the present invention which illustrates an example of a Web server system.

In FIG. 1, a Web server 100 has a storage device managing unit 101 which constitutes storage device managing means; an input device 102 which is composed of a keyboard and a mouse and constitutes manipulating means; PCI interface units 103, 105 which are connected to a bus 104; an external storage device 106 composed of a magnetic disk or the like; a disk control unit 107 constituting attribute switching means; an attribute controller 108 constituting attribute-switching-signal generating means; and an attribute setting unit 109. Note that other bus interfaces may be used for the PCI interface units 103, 105.

The storage device managing unit 101 has an attribute control unit 110 which constitutes a second attribute control means, and an attribute-setting-information managing unit 111 which constitutes attribute information storage means. Note that the hardware of the storage device managing unit 101 is composed of a central processing unit (CPU) and a main memory. Further, an operating system (OS) and other software stored in the storage device 106 are stored into the main memory, and the CPU executes the OS and the software stored in the main memory. This realizes the functions of the attribute control unit 110 and of the attribute-setting-information managing unit 111. Further, the function in which the storage device managing unit 101 controls the storage device 106, is obtained by the CPU executing the operating system.

Linux is used as the OS in accordance with the present embodiment. When Linux is used, the attribute information in the external storage device is stored into the main memory (i.e., the attribute-setting-information managing unit 111 according to the present embodiment), and the attribute information which is stored in the main memory is used to learn the current attributes of the storage device. As such, when the attributes recognized by on the OS side differ from the actual attributes of the storage device, there are cases where the OS cannot perform normal control of the storage device 106. As a result, the computer cannot operate normally. In order for the computer to operate normally, it is necessary to establish correspondence, or synchronization, between the attributes recognized by the OS and the actual attributes of the storage device. This is also applicable in any OS besides Linux such as Unix or the like in which synchronization must be established between the storage device attributes recognized by the OS and the actual attributes of the storage device.

The attribute control unit 110 performs an interface with an attribute control unit 113 described below. Further, the attribute-setting-information managing unit 111 manages the attribute information of the storage device 106.

The disk control unit 107 performs the interface function between the information inside the storage device 106 and the storage device managing unit 101 side. The disk control unit 107 possesses a function of physically performing the control of the attribute settings, such as read/write, read only, valid/invalid and the like, for each of the storage areas set in the storage device 106.

The attribute controller 108 has an attribute-setting-status storage unit 112, and the attribute control unit 113 which constitutes a first attribute control means. The attribute-setting-status storage unit 112 functions to issue attribute information out to the disk control unit 107 and to the storage device managing unit 101. The attribute control unit 113 functions to issue an attribute setting request to the attribute control unit 110 in the storage device managing unit 101, and also functions to execute a modification of an attribute setting of the storage device 106 through the disk control unit 107, based on a control from the attribute setting unit 109. Further, the attribute control unit 113 has time-measuring means inside it. In a case where the attribute control unit 113 does not detect the attribute modification permission issued from the attribute control unit 110 within a predetermined period of time, the attribute control unit 113 detects a time-out by the time-measuring means, and forcibly executes modification of the attribute settings of the storage device 106.

The attribute setting unit 109 has a switch unit 114, a setting control unit 115 and a communications unit 116. The switching unit 114 is composed of a hardware switch for setting and modifying the attributes of the storage device 106. The setting control unit 115 functions to transmit to the attribute-setting-status storage unit 112 the attribute information which should be set in the storage device 106, according to setting content from the switch unit 114 or setting content from the communications unit 116. The setting control unit 115 also functions to transmit to the attribute control unit 113 an instruction to switch the setting according to the setting which is transmitted to the attribute-setting-status storage unit 112. The communications unit 116 is for connecting the server system 100 to the network (for example, the Intranet), and is composed of an interface which enables the control of the attribute setting of the storage device 106 to be executed from a remote location.

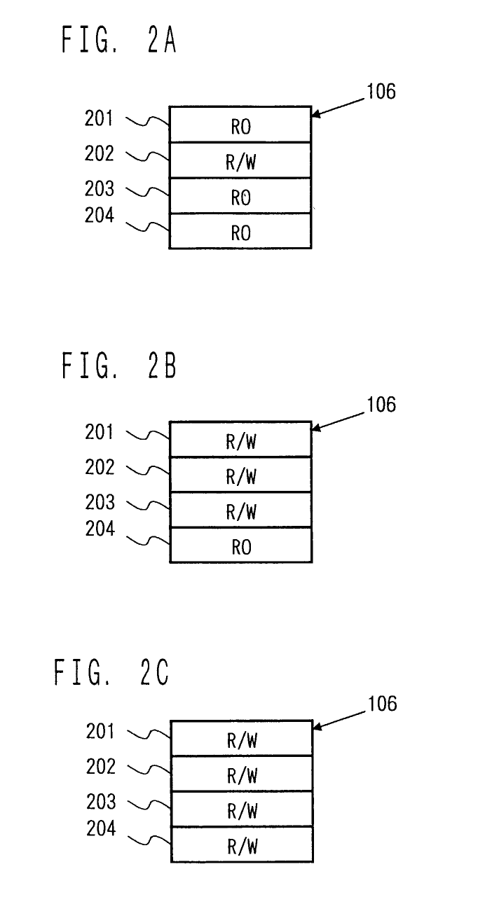

FIGS. 2A to 2C are diagrams showing attributes set for each storage area (partition) 201-204 in the storage device 106. In FIGS. 2A to 2C, the partitions are set up in the storage device 106 to divide the storage device 106 into the plurality of storage areas 201-204. As an example, the storage area 201 is the area where the operating system (OS) and server software and other programs are stored, the storage area 202 serves as the swap area when virtual memory is used, the storage area 203 is the area storing the first content data, and the storage area 204 is the area storing the second content data.

FIG. 2A is a diagram showing an attribute setting status of the mode (i.e., the open mode) in which the system is available for use by the user but the modification of the stored content in the storage device 106 is prohibited. In the diagram, the storage areas 201, 203 and 204 are set as read only (RO), and the storage area 202 is set as read/write (R/W). FIG. 2B is a diagram showing the attribute settings of the mode (i.e., the maintenance mode) in which the administrator of the content data is allowed to modify his/her own content data. In the diagram, the storage areas 201-203 are set as read/write (R/W), and the storage area 204 is set as read only (RO). Further, FIG. 2C is a diagram showing the attribute settings of the mode (i.e., the full-maintenance mode) in which the server administrator is allowed to modify all the storage areas of the storage device 106. In the diagram, all the storage areas 201-204 are set as read/write (R/W).

Below, detailed explanation of operations of the present embodiment are explained with reference to FIG. 1 and FIGS. 2A to 2C.

It is assumed here that the storage device 106 attribute information corresponding to the open mode, to the maintenance mode and to the full-maintenance mode are each stored in the attribute-setting-status storage unit 112.

The setting of the attribute information into the storage device 106 is performed either via the network from a terminal which is not shown in the diagram, or by manipulating the switch unit 114. For example, in the case where the attribute information corresponding to one of the above modes is set into the attribute-setting-status storage unit 112 from the terminal via the network, the attribute information for the respective mode is inputted into the setting control unit 115 from the terminal via the communications unit 116.

Further, in the case where the storage device 106 attribute information corresponding to each mode is to be inputted into the attribute-setting-status storage unit 112 by means of the switch unit 114, the administrator manipulates the switch unit 114 to input the attribute information for each mode into the setting control unit 115. The setting control unit 115 receives the attribute information for each mode from the communications unit 116 or from the switch unit 114, and stores the attribute information for the each mode into attribute-setting-status storage unit 112. Accordingly, the attribute information for each storage area 201-204 in the storage device 106 corresponding to each mode, is stored into the attribute-setting-status storage unit 112 as shown in FIGS. 2A to 2C.

Note that even in a case where the attribute information in the attribute-setting-status storage unit 112 is to be modified to attribute information other than the above-mentioned 3 types, the modification can be performed as outlined above.

In the initial state the storage device 106 is in the open mode, which is to say that the attributes are as shown in FIG. 2A, which is to say that the storage areas 201, 203 and 202 are set as read only, and the storage area 202 is set as read/write. Further, the attribute information corresponding to the open mode is also stored in the attribute-setting-information managing unit 111.

In this state, since the storage device 106 attribute information recognized by the OS and the actual attribute of the storage device 106 are synchronized with each other, the server system 100 can operate normally. In other words, the OS can determine the access method to each of the storage areas 201-204 in the storage device 106 according to the attribute information stored in the attribute-setting-information managing unit 111, and can perform normal control of the storage device 106 via the disk control unit 107.

In a case where the storage device 106 is to be switched to the maintenance mode from this state, the administrator manipulates a terminal not shown in the diagram, whereby via the network the terminal outputs to the attribute setting unit 109 a first attribute-switch-request signal for giving an instruction to switch the settings to the maintenance mode. The first attribute-switch-request signal is outputted to the setting control unit 115 by the communications unit 116.

Alternatively, the administrator manipulates the switch unit 114, whereby the switch unit 114 outputs to the setting control unit 115 the first attribute-switch-request signal for requesting the settings to be switched to the maintenance mode.

The first attribute-switch-request signal is outputted to the attribute controller 108 by the setting control unit 115. The attribute control unit 113 responds to the first attribute-switch-request signal and sends the attribute-switch-request signal to the storage device managing unit 101 via the PCI interface unit 105, the bus 104 and the PCI interface units 103, and also starts a time-measuring operation. The attribute-switch-request signal is a signal corresponding to the first attribute-switch-request signal, and in the present case it is a signal requesting the switch to the attribute information of the maintenance mode.

At the storage device managing unit 101, the attribute control unit 110 responds to the attribute-switch-request signal and reads out the maintenance mode attribute information from the attribute-setting-status storage unit 112, and then stores this in the attribute-setting-information managing unit 111. This updates the attribute information being recognized by the OS from the attribute information for the open mode to the attribute information for the maintenance mode. Then the attribute control unit 110 issues a modification permission signal to the attribute controller 108.

When the modification permission signal is received, the attribute control unit 113 recognizes from this that the modification of the attribute information on the OS side has completed, and sends to the disk control unit 107 an attribute-switching-signal which gives an instruction to change the storage device 106 attribute information to the attributes for the maintenance mode.

In response to the attribute-switching-signal, the disk control unit 107 reads out the maintenance mode attribute information stored in the attribute-setting-status storage unit 112, and switches the attributes of each storage area in the storage device 106 to the attributes which correspond to the attribute-switching-signal. Accordingly, the attributes of each storage area in the storage device 106 are set to the attributes for the maintenance mode, which is to say that the storage areas 201-203 are set as read/write, and the storage area 204 is set as read only.

On the other hand, the attribute control unit 113 starts the time-measuring operation simultaneously with sending the attribute-switch-request signal to the storage device managing unit 101. In a case where the attribute control unit 113 does not receive the modification permission signal within a given duration of time, it forcibly outputs the first setting switch signal corresponding to the attribute-switch-request signal, to the disk control unit 107.

In response to the first setting switch signal, the disk control unit 107 reads out the maintenance mode attributes stored in the attribute-setting-status storage unit 112, and sets the attributes into the storage device 106. This enables the setting of the storage device 106 attributes to be forcedly set into the maintenance mode. Thus, even in a case where the modification permission signal from the storage device managing unit 101 is delayed, it is still possible to synchronize the attributes recognized by the OS with the attributes of the storage device 106.

To switch the settings from the open mode to the maintenance mode, or to switch to the open mode from the maintenance mode or from the full-maintenance mode, the mode is designated from the terminal via the network or is designated from the switch unit 114, whereby the mode of the storage device 106 is switched in a manner similar to that described above.

As described above, the system for controlling attributes of a storage device according to the present embodiment is characterized by comprising: the storage device 106; the storage device managing unit 101 including the attribute-setting-information managing unit 111 for storing attribute information with respect to the storage device 106, which controls the storage device 106 based on the attribute information stored in the attribute-setting-information managing unit 111 and modifies the attribute information stored in the attribute-setting-information managing unit 111 to the attributes corresponding to the attribute-set-request signal; the attribute controller 108 for receiving the attribute-switch-request signal and outputting to the storage device managing unit 101 the attribute-set-request signal corresponding to the attribute-switch-request signal, and also for outputting the attribute-switching-signal corresponding to the attribute-switch-request signal; and a disk control unit 107 for switching the attributes of the storage device 106 to attributes corresponding to the attribute-switching-signal. Here, the CPU executes an OS to achieve the function in which the storage device managing unit 101 controls the storage device 106, and the OS is an OS in which the attributes of the storage device 106 as recognized by the OS must be synchronized with the actual attributes of the storage device 106 (Linux or Unix according to the present embodiment).

Therefore, it becomes possible to synchronize the attributes recognized by the OS with the attributes of the storage device 106 when switching the attributes of the storage device 106, thus preventing occurrence of an operational abnormality in the server 100.

Note that, in accordance with the present embodiment, when the attribute control unit 113 has measured out the predetermined given time duration, the setting switching signal corresponding to the attribute-switch-request signal is outputted. However, it is also possible to output a setting switching signal for switching the mode to a given mode which has been determined in advance (for example, the full-maintenance mode).

Further, although explained above in connection with the example of the Web server used on the Internet, the above-mentioned embodiment may be used in a server to be used in various types of networks such as an intranet.

Further, the switching of the attributes of the storage device 106 is performed via the network or by a switching manipulating with the switch unit 114. However, it is also possible to manipulate the input device 102 to make the storage device managing unit 101 execute a mode-switch-signal generating program, to thereby switch the storage device 106 attributes by causing the input device 102 to give an instruction indicating which mode to switch to.

In accordance with the system for controlling the attributes of the storage device according to the present invention, it becomes possible to prevent an operational abnormality from occurring when switching the attributes of the storage device.

What is claimed is:

1. A system for controlling attributes of a storage device, comprising:
a storage device;
storage device managing means including attribute information storage means for storing attribute information indicating the attributes of the storage device, which controls the storage device based on the attribute information stored in the attribute information storage means and also modifies the attribute information stored in the attribute information storage means to attributes corresponding to an attribute-switch-request signal;
attribute-switching-signal generating means for receiving an attribute-switch-request signal and outputting to the storage device managing means the attribute-set-request signal which corresponds to the attribute-switch-request signal, and also for outputting an attribute-switching-signal that corresponds to the attribute-switch-request signal; and
attribute switching means for switching the attributes of the storage device to the attributes corresponding with the attribute-switching-signal.

2. A system for controlling attributes of a storage device according to claim 1, wherein the function in which the storage device managing means controls the storage device is achieved by a CPU executing the operating system, and the operating system is an operating system in which it is necessary to synchronize the storage device attributes which are being recognized by the operating system with the attributes that are set in the storage device.

3. A system for controlling attributes of a storage device according to claim 2, wherein the operating system is Linux or Unix.

4. A system for controlling attributes of a storage device according to claim 1, wherein the storage device managing means receives the attribute-switch-request signal and outputs an attribute modification permission signal, and in response to the attribute modification permission signal, the attribute-switching-signal generating means outputs the attribute-switching-signal.

5. A system for controlling attributes of a storage device according to claim 4, wherein in response to the attribute-set-request signal, the storage device managing means modifies the attribute information stored in the attribute information storage means to attributes that correspond to the attribute-set-request signal and then outputs the attribute modification permission signal.

6. A system for controlling attributes of a storage device according to claim 4, wherein the attribute-switching-signal generating means has a time-measuring means which starts a time-measuring operation simultaneous with the outputting of the attribute-set-request signal, and when the time-measuring means measures out a given time duration before receiving the attribute modification permission signal, the output of the attribute-switching-signal is forced.

7. A system for controlling attributes of a storage device according to claim 2, wherein the storage device is divided into a plurality of storage areas with at least the operating system and data stored therein.

8. A system for controlling attributes of a storage device according to claim 1, wherein the attribute-switching-signal generating means receives the attribute-switch-request signal via a network.

9. A system for controlling attributes of a storage device according to claim 1, further comprising a switch unit for inputting the attribute-switch-request signal, wherein the attribute-switching-signal generating means receives the attribute-switch-request signal from the switch unit.

10. A system for controlling attributes of a storage device according to claim 1, wherein the attribute-switching-signal generating means comprises attribute-setting-status storage means for storing the attribute information set in the storage device; and attribute control means for responding to the attribute-switch-request signal by outputting the attribute-set-request signal, and also for responding to the attribute modification permission signal by outputting as the attribute-switching-signal the attribute information stored in the attribute-setting-status storage means.

11. A system for controlling attributes of a storage device according to claim 10, wherein the attribute-setting-status storage means stores the attribute information inputted from the network or from the switch unit.
